(19) United States
(12) Patent Application Publication
(10) Pub. No.: US 2026/0048515 A1
(43) Pub. Date: Feb. 19, 2026

(54) ROBOT SYSTEM

(71) Applicant: AISAN KOGYO KABUSHIKI KAISHA, Obu-shi (JP)

(72) Inventors: Taisuke KAGAU, Kariya-shi (JP); Yuichiro IMAI, Tokai-shi (JP); Yuki EGUCHI, Kariya-shi (JP)

(21) Appl. No.: 19/302,260

(22) Filed: Aug. 18, 2025

(30) Foreign Application Priority Data
Aug. 19, 2024 (JP) 2024-137917

(51) Int. Cl. B25J 13/08; B25J 9/16

(52) U.S. Cl. CPC B25J 13/088; B25J 9/1612; B25J 9/162

(57) ABSTRACT

A robot system may include a movable stand; a robot mounted on the movable stand; a working machine mounted on the movable stand at a different position from the robot; a first placement region at which a workpiece is placed before the working machine works on the workpiece; and a second placement region at which the workpiece is placed after the working machine has worked on the workpiece. The robot may include a gripper for gripping the workpiece; a first recognizer for recognizing a state of the workpiece at the first placement region; and a second recognizer for recognizing a state of the second placement region.

### CROSS REFERENCE TO RELATED APPLICATION

This application claims priority to Japanese Patent Application No. 2024-137917 filed on Aug. 19, 2024. The entire content of the priority application is incorporated herein by reference.

### TECHNICAL FIELD

The art disclosed herein relates to a robot system.

### BACKGROUND ART

Japanese Patent Application Publication No. 2019-058954 describes a robot system. This robot system includes a movable stand, a robot mounted on the movable stand, and a working machine mounted on a working stand different from the movable stand. The robot system further includes a first placement region at which a workpiece is placed before the working machine works on the workpiece and a second placement region at which the workpiece is placed after the working machine has worked on the workpiece.

In the robot system of Japanese Patent Application Publication No. 2019-058954, the work on the workpiece may not proceed smoothly since the movable stand on which the robot is mounted is distanced from the working stand on which the working machine is mounted. For example, it is difficult to adjust the robot's amount of motion because it depends on the distance between the robot and the working machine, which may make it difficult to proceed the work smoothly. The disclosure herein provides a technology for facilitating a series of actions performed on a workpiece.

### SUMMARY

A robot system disclosed herein may comprise a movable stand; a robot mounted on the movable stand; a working machine mounted on the movable stand at a different position from the robot; a first placement region at which a workpiece is placed before the working machine works on the workpiece; and a second placement region at which the workpiece is placed after the working machine has worked on the workpiece. The robot may comprise a gripper configured to grip the workpiece; a first recognizer configured to recognize a state of the workpiece at the first placement region; and a second recognizer configured to recognize a state of the second placement region. The robot may be configured to perform a first control process in which the robot grips the workpiece with the gripper after the state of the workpiece has been recognized by the first recognizer; a second control process in which the robot moves the workpiece gripped with the gripper to the working machine; a third control process in which the robot moves the workpiece gripped with the gripper to the second placement region after the working machine has worked on the workpiece; and a fourth control process in which the robot places the workpiece gripped with the gripper onto the second placement region after the second placement region has been recognized by the second recognizer.

### BRIEF DESCRIPTION OF DRAWINGS

FIG. 1 is a schematic perspective view (1) of a robot system according to an embodiment.

FIG. 2 is a schematic perspective view (2) of the robot system according to the embodiment.

FIG. 3 is a schematic top view of the robot system according to the embodiment.

FIG. 4 is a cross-sectional view of a belt conveyor according to an embodiment.

FIG. 5 is a cross-sectional view of a container according to an embodiment.

FIG. 6 is a flowchart of a control process according to an embodiment.

FIG. 7 is a flowchart of a control process according to a variant.

### DETAILED DESCRIPTION

In one aspect of the present teachings, a robot system may comprise a movable stand; a robot mounted on the movable stand; a working machine mounted on the movable stand at a different position from the robot; a first placement region at which a workpiece is placed before the working machine works on the workpiece; and a second placement region at which the workpiece is placed after the working machine has worked on the workpiece. The robot may comprise a gripper configured to grip the workpiece; a first recognizer configured to recognize a state of the workpiece on the first placement region; and a second recognizer configured to recognize a state of the second placement region. The robot may be configured to perform a first control process in which the robot grips the workpiece with the gripper after the state of the workpiece has been recognized by the first recognizer; a second control process in which the robot moves the workpiece gripped with the gripper to the working machine; a third control process in which the robot moves the workpiece gripped with the gripper to the second placement region after the working machine has worked on the workpiece; and a fourth control process in which the robot places the workpiece gripped with the gripper onto the second placement region after the second placement region has been recognized by the second recognizer.

The above configuration allows a series of actions on the workpiece to be performed smoothly since the robot and the working machine are mounted on the same movable stand. For example, when the robot moves the workpiece from the first placement region to the working machine, positional misalignment can be suppressed, which facilitates the series of actions. Further, positional misalignment can be also suppressed when the workpiece is moved from the working machine to the second placemen region, which also facilitates the series of actions.

In one aspect of the present teachings, the robot may be further configured to perform a control process in which the robot changes a gripped position on the workpiece by the gripper after the working machine has worked on the workpiece and before the third control process is performed.

The above configuration facilitates the placement of the workpiece onto the second placement region in the subsequent fourth control process, by changing the gripped position on the workpiece gripped with the gripper.

In one aspect of the present teachings, the robot system may further comprise a solar power generation device configured to supply power to the robot.

The above configuration allows for a cost reduction by utilizing natural energy.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved robot systems.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

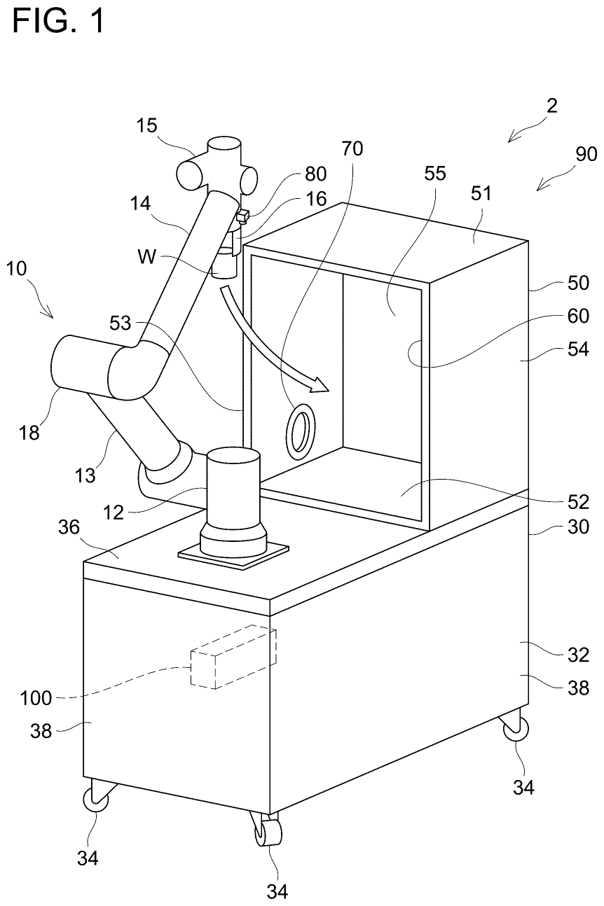

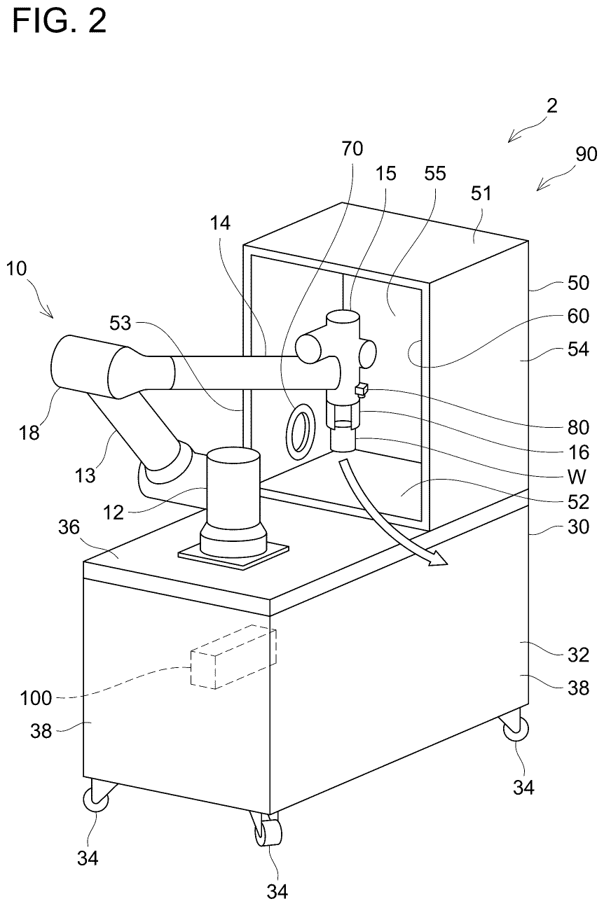

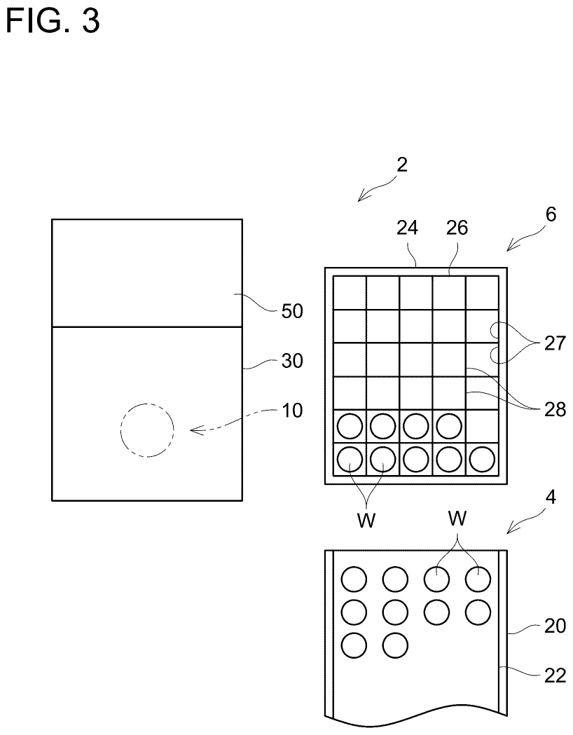

A robot system 2 according to an embodiment is described with reference to the drawings. As shown in FIGS. 1 and 2, the robot system 2 according to the embodiment comprises a movable stand 30, a working robot 10 mounted on the movable stand 30, and a working machine 90 mounted on the movable stand 30 at a different position from the working robot 10. As shown in FIG. 3, the robot system 2 further comprises a first placement region 4 and a second placement region 6. The placement regions 4 and 6 are located apart from the movable stand 30.

As shown in FIGS. 1 and 2, the movable stand 30 comprises a body 32 and a plurality of wheels 34 attached to the body 32. The plurality of wheels 34 allows the movable stand 30 to be movable in multiple directions. The plurality of wheels 34 is attached to a lower portion of the body 32. The movable stand 30 is movable in multiple directions, for example, on a floor. In a variant, the movable stand 30 may be movable on rails. The movable stand 30 can be moved manually or automatically.

The body 32 of the movable stand 30 has, for example, a box shape. The body 32 comprises an upper surface portion 36 on which the working robot 10 and a box 50 are mounted. The body 32 supports the working robot 10 and the box 50. The body 32 is constituted of, for example, an aluminum alloy.

The working robot 10 is fixed to the upper surface portion 36 of the movable stand 30. The position of the working robot 10 within the upper surface portion 36 of the movable stand 30 can be changed as desired. The working robot 10 is, for example, an articulated robot comprising a plurality of arms. For example, the working robot 10 can grip a workpiece W to be captured (a workpiece W to be worked on). The working robot 10 can also move a workpiece W while gripping it. For example, the working robot 10 can move a workpiece W from the outside to the inside of the box 50 or from the inside to the outside of the box 50.

The configuration of the working robot 10 is not particularly limited. The working robot 10 comprises, for example, a base end portion 12, an arm 18, a first imaging device 80, and a controller 100. The base end portion 12 of the working robot 10 is fixed to the upper surface portion 36 of the movable stand 30. The arm 18 of the working robot 10 comprises a first portion 13, a second portion 14, a distal end portion 15, and a gripper 16.

The first portion 13 is connected to the base end portion 12. The first portion 13 is rotatable relative to the base end portion 12. The first portion 13 is rotatable, for example, about one or more axes. The second portion 14 is connected to the first portion 13. The second portion 14 is rotatable relative to the first portion 13. The second portion 14 is rotatable, for example, about one or more axes. The distal end portion 15 is connected to the second portion 14. The distal end portion 15 is rotatable relative to the second portion 14. The distal end portion 15 is rotatable, for example, about one or more axes.

The gripper 16 is connected to the distal end portion 15. The gripper 16 is configured to grip a workpiece W to be captured. The gripper 16 comprises, for example, a plurality of claws and grips the workpiece W by the claws approaching each other or separating from each other. The gripper 16 is also referred to as a chuck.

The first imaging device 80 is attached to the distal end portion 15. The first imaging device 80 is configured to capture one or more workpieces W placed in the first placement region 4 (see FIG. 3). The first imaging device 80 captures workpieces W to acquire images thereof. The first imaging device 80 acquires still images and/or moving images of the workpieces W.

The first imaging device 80 is further configured to capture the first placement region 4 and the second placement region 6 (see FIG. 3). The first imaging device 80 captures the first placement region 4 to acquire an image thereof. The first imaging device 80 also captures the second placement region 6 to acquire an image thereof. The first imaging device 80 acquires still images and/or moving images of the first placement region 4 and the second placement region 6. The first imaging device 80 may comprise a lighting member configured to light an object to be captured.

The controller 100 of the working robot 10 comprises, for example, a CPU, a ROM, a RAM, and the like and performs various control processes and other processes associated with the working robot 10 according to predetermined programs. The controller 100 is located, for example, within the body 32 of the movable stand 30.

The controller 100 is configured to recognize the state (e.g., the orientation, position, and angle) of each workpiece W based on the image(s) the first imaging device 80 acquired by capturing the workpieces W. Further, the controller 100 is configured to recognize the state (e.g., the orientation, position, and angle) of the first placement region 4 based on the image(s) the first imaging device 80 acquired by capturing the first placement region 4. Also, the controller 100 is configured to recognize the state (e.g., the orientation, position, and angle) of the second placement region 6 based on image(s) the first imaging device 80 acquired by capturing the second placement region 6.

The working robot 10 may comprise components other than the above-described components. For example, the working robot 10 may comprise an extendable member extendable in a front-rear direction. The working robot 10 may move a workpiece W from the outside to the inside of the box 50 or from the inside to the outside of the box 50 by the extendable member extending toward and contracting from the box 50 in the front-rear direction.

The configuration of the working robot 10 is not particularly limited.

Now, the working machine 90 of the robot system 2 is described. The working machine 90 comprises the light-blocking box 50 mounted on the movable stand 30 at a different position from where the working robot 10 is and a second imaging device 70 attached to the box 50.

The box 50 is fixed to the upper surface portion 36 of the movable stand 30. The box 50 is mounted on the movable stand 30 at a different position from the working robot 10. The working robot 10 and the box 50 are adjacent to each other on the upper surface portion 36 of the movable stand 30. The working robot 10 and the box 50 are arranged to face each other. The position of the box 50 within the upper surface portion 36 of the movable stand 30 can be changed as desired.

The box 50 blocks external light. That is, the box 50 prevents external light from entering the inside of the box 50. The box 50 defines a space therein, and a workpiece W to be captured can be housed in the space.

The box 50 comprises, for example, an upper member 51, a lower member 52, a left member 53, a right member 54, and a rear member 55. The upper member 51, the left member 53, the right member 54, and the rear member 55 all block external light (prevent external light from entering the inside of the box 50). For example, the upper member 51 prevents light from entering the inside of the box 50 from above. The left member 53 and the right member 54 prevent light from entering the inside of the box 50 from sides (from left and right), respectively. The rear member 55 prevents light from entering the inside of the box 50 from the rear. The lower member 52 is fixed to the upper surface portion 36 of the movable stand 30. The lower member 52 prevents light reflex. Each of these members is, for example, a black plate-shaped member.

The box 50 comprises an opening 60. The opening 60 is open to the front of the box 50 (toward the working robot 10). The opening 60 is located between the rear member 55 of the box 50 and the working robot 10. The opening 60 faces the working robot 10. In the robot system 2, a workpiece W to be captured is moved into and out of the box 50 through the opening 60.

The second imaging device 70 is attached to the box 50. The second imaging device 70 is fixed to, for example, the left member 53 of the box 50. In a variant, the second imaging device 70 may be fixed to the right member 54, the rear member 55, the upper member 51, or the lower member 52 of the box 50.

The second imaging device 70 is configured to capture the inside of the box 50. The second imaging device 70 can capture a workpiece W in the box 50 when it is there. The second imaging device 70 captures a workpiece W to acquire an image thereof. The second imaging device 70 acquires a still image and/or moving image of a workpiece W. The second imaging device 70 may comprise a lighting member configured to light an object to be captured.

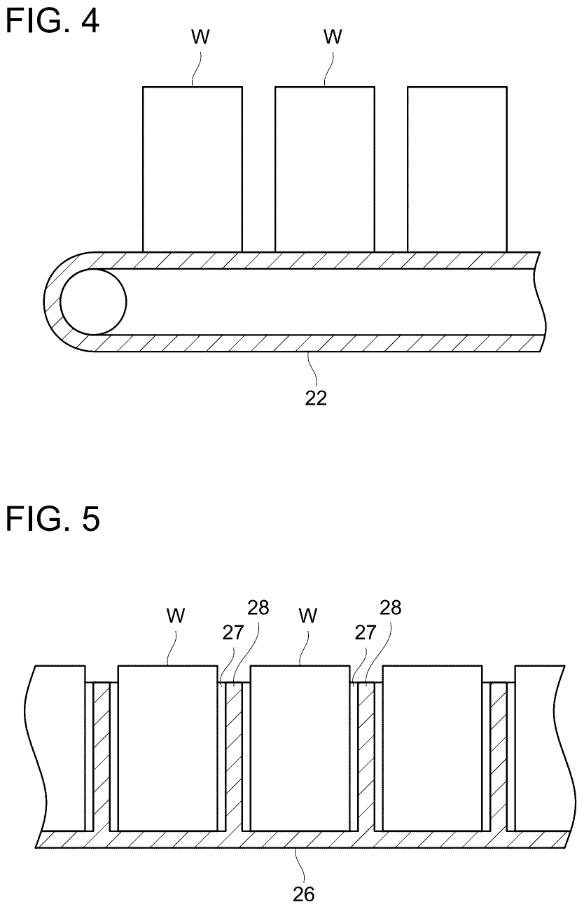

Now, the first placement region 4 and the second placement region 6 (see FIG. 3) are described. The first placement region 4 is where workpieces W are placed before being gripped by the working robot 10. The first placement region 4 is where workpieces W are placed before being captured by the second imaging device 70 of the working machine 90. The first placement region 4 is located apart from the movable stand 30. In this embodiment, the first placement region 4 comprises a support stand 20 and a belt conveyor 22 on the support stand 20. As shown in FIG. 4, multiple workpieces W are placed on the belt conveyor 22. The belt conveyor 22 can convey multiple workpieces W placed thereon.

The second placement region 6 is where workpieces W are placed after being gripped by the working robot 10. The second placement region 6 is where workpieces W are placed after being captured by the second imaging device 70 of the working machine 90. The second placement region 6 is located apart from the movable stand 30. In this embodiment, the second placement region 6 comprises a support stand 24 and a container 26 on the support stand 24. As shown in FIG. 5, multiple workpieces W are placed in the container 26. The container 26 comprises a plurality of container chambers 27 for housing a plurality of workpieces W. The container 26 comprises a plurality of partitions 28 that separate adjacent container chambers 27.

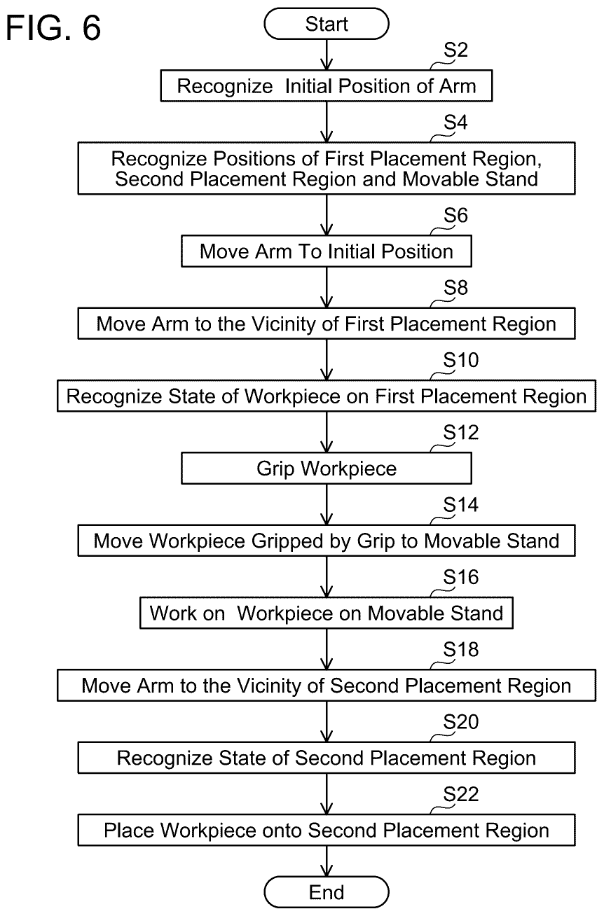

Now, a control process performed in the robot system 2 according to the embodiment is described with reference to FIG. 6. As shown in FIG. 6, in S2 of the control process of this embodiment, the controller 100 of the working robot 10 recognizes an initial position of the arm 18. For example, the controller 100 recognizes the initial position of the arm 18 based on a setting value input by a user to a predetermined input unit (not illustrated).

In S4, the controller 100 recognizes positions of the first placement region 4, the second placement region 6, and the movable stand 30. For example, the controller 100 recognizes positions of the first placement region 4, the second placement region 6, and the movable stand 30 based on setting values input by the user to the predetermined input unit (not illustrated).

In S6, the working robot 10 moves the arm 18 to the initial position recognized in S2. For example, the working robot 10 moves the arm 18 to the initial position by appropriately moving the portions 13, 14, 15, and 16 of the arm 18.

In S8, the working robot 10 moves the arm 18 to near the first placement region 4. The working robot 10 moves the arm 18 to near the first placement region 4 by appropriately moving the portions 13, 14, 15, and 16 of the arm 18.

In S10, the controller 100 of the working robot 10 recognizes the state of a workpiece W placed at the first placement region 4. Specifically, the controller 100 recognizes the state of the workpiece W based on an image of the workpiece W acquired by the first imaging device 80 capturing the workpiece W. The first imaging device 80 captures the workpiece W near the first placement region 4 after the arm 18 of the working robot 10 has been moved to near the first placement region 4.

In S12, the working robot 10 grips the workpiece W (i.e., the workpiece W at the first placement region 4) with the gripper 16 after the state of the workpiece W has been recognized in S10. In S14, the working robot 10 moves the arm 18 while gripping the workpiece W with the gripper 16 to move the gripped workpiece W to the movable stand 30. The working robot 10 moves the workpiece W to the movable stand 30 by appropriately moving the portions 13, 14, 15, and 16 of the arm 18.

In S16, the working robot 10 and the second imaging device 70 work on the workpiece W gripped with the gripper 16 at the movable stand 30. More specifically, the working robot 10 moves the gripped workpiece W, which is positioned outside the box 50, into the box 50 (see FIG. 1). The working robot 10 moves the gripped workpiece W from the outside of the box 50 to the inside of the box 50 by appropriately moving the portions 13, 14, 15, and 16 of the arm 18. The working robot 10 keeps gripping the workpiece W inside the box 50. Then, the second imaging device 70 captures the workpiece W positioned inside the box 50. The second imaging device 70 captures the workpiece W gripped by the working robot 10 inside the box 50. The second imaging device 70 captures the workpiece W to acquire an image thereof. The image information of the workpiece W acquired by the second imaging device 70 is transmitted to the controller 100, for example, via wireless communication or wired communication. In a variant, the image information of the workpiece W may be transmitted to an external device different from the robot system 2 via wireless communication or wired communication.

Then, the working robot 10 moves the gripped workpiece W inside the box 50 to the outside of the box 50 (see FIG. 2). The working robot 10 moves the gripped workpiece W from the inside of the box 50 to the outside of the box 50 after the second imaging device 70 has captured the workpiece W inside the box 50.

After the work on the workpiece W has been completed, the working robot 10 moves the arm 18 to near the second placement region 6 in S18. The working robot 10 moves the arm 18 to near the second placement region 6 by appropriately moving the portions 13, 14, 15, and 16 of the arm 18.

In S20, the controller 100 of the working robot 10 recognizes the state of the second placement region 6. Specifically, the controller 100 recognizes the state of the second placement region 6 based on an image of the second placement region 6 acquired by the first imaging device 80 capturing the second placement region 6. The first imaging device 80 captures the second placement region 6 near the second placement region 6 after the arm 18 of the working robot 10 has been moved to near the second placement region 6.

In S22, the working robot 10 places the workpiece W gripped with the gripper 16 onto the second placement region 6. The working robot 10 places the workpiece W into a container chamber 27 at the second placement region 6. After this, the robot system 2 repeats the above-described series of actions several times.

### Advantageous Effects

The robot system 2 according to the embodiment has been described above. As apparent from the description above, the robot system 2 comprises the movable stand 30, the working robot 10 mounted on the movable stand 30, and the working machine 90 mounted on the movable stand 30 at a different position from the working robot 10. The robot system 2 further comprises the first placement region 4 at which a workpiece W is placed before the working machine 90 works on the workpiece W and the second placement region 6 at which the workpiece W is placed after the working machine 90 has worked on the workpiece W. The working robot 10 comprises the gripper 16 configured to grip the workpiece W. The controller 100 of the working robot 10 is configured to recognize the state of the workpiece W at the first placement region 4. The controller 100 is also configured to recognize the state of the second placement region 6. The working robot 10 is configured to perform, using the controller 100, a first control process in which the working robot 10 grips the workpiece W with the gripper 16 after the state of the workpiece W has been recognized by the controller 100, a second control process in which the working robot 10 moves the workpiece W gripped with the gripper 16 to the working machine 90, a third control process in which the working robot 10 moves the workpiece W gripped with the gripper 16 to the second placement region 6 after the working machine 90 has worked on the workpiece W, and a fourth control process in which the working robot 10 places the workpiece W gripped with the gripper 16 onto the second placement region 6 after the second placement region 6 has been recognized by the controller 100.

The configuration above facilitates a series of actions on the workpiece W since the working robot 10 and the working machine 90 are mounted on the same movable stand 30. For example, positional misalignment can be prevented when the workpiece W is moved by the working robot 10 from the first placement region 4 to the working machine 90, which facilitates the series of actions. Positional misalignment can be also prevented when the workpiece W is moved from the working machine 90 to the second placement region 6, which similarly facilitates the series of actions.

### Correspondence Relationships

S10 and S12 are an example of “first control process”. S14 and S16 are an example of “second control process”. S18 is an example of “third control process”. S20 and S22 are an example of “fourth control process”.

### Variants

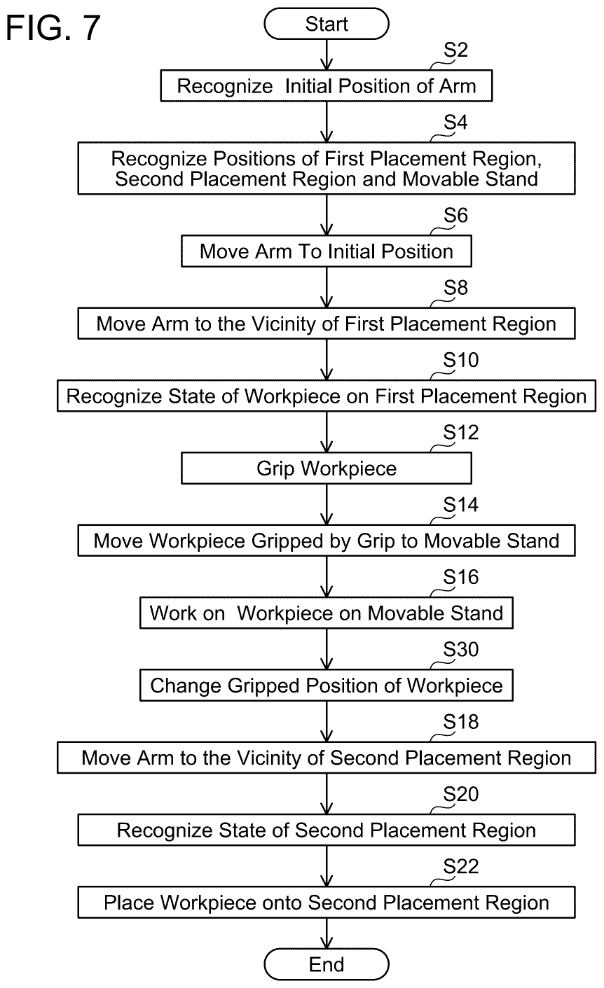

(1) In a variant, the working robot 10 may perform S30 after S16 and before S18, as illustrated in FIG. 7. In S30, the working robot 10 changes the gripped position on the workpiece W gripped with the gripper 16. More specifically, the working robot 10 places the workpiece W gripped with the gripper 16 onto the upper member 51 of the box 50, and then changes the orientation of the gripper 16 and grips the workpiece W again with the gripper 16.

The working robot 10 changes the gripped position on the workpiece W gripped with the gripper 16 after the working machine 90 has worked on the workpiece W and before the third control process is performed. This configuration facilitates the placement of the workpiece W onto the second placement region 6 in the following fourth control process, by changing the gripped position on the workpiece W gripped with the gripper 16.

(2) In a variant, the robot system 2 may comprise a solar power generation device configured to supply power to the working robot 10. The solar power generation device may be mounted, for example, on the movable stand 30. This configuration allows for a cost reduction by use of natural energy.

What is claimed is:

1. A robot system comprising:
a movable stand;
a robot mounted on the movable stand;
a working machine mounted on the movable stand at a different position from the robot;
a first placement region at which a workpiece is placed before the working machine works on the workpiece; and
a second placement region at which the workpiece is placed after the working machine has worked on the workpiece,
wherein
the robot comprises:
a gripper configured to grip the workpiece;
a first recognizer configured to recognize a state of the workpiece at the first placement region; and
a second recognizer configured to recognize a state of the second placement region, and
the robot is configured to perform:
a first control process in which the robot grips the workpiece with the gripper after the state of the workpiece has been recognized by the first recognizer;
a second control process in which the robot moves the workpiece gripped with the gripper to the working machine;
a third control process in which the robot moves the workpiece gripped with the gripper to the second placement region after the working machine has worked on the workpiece; and
a fourth control process in which the robot places the workpiece gripped with the gripper onto the second placement region after the second placement region has been recognized by the second recognizer.

2. The robot system according to claim 1, wherein
the robot is further configured to perform a control process in which the robot changes a gripped position on the workpiece gripped with the gripper after the working machine has worked on the workpiece and before the third control process is performed.

3. The robot system according to claim 1, further comprising a solar power generation device configured to supply power to the robot.

4. The robot system according to claim 2, further comprising a solar power generation device configured to supply power to the robot.
